(19) United States
(12) Patent Application Publication
(10) Pub. No.: US 2012/0137904 A1
(43) Pub. Date: Jun. 7, 2012

(54) PERFORATING AND COMPRESSING MACHINE FOR PLASTIC BOTTLES, METAL CANS AND THE LIKE

(76) Inventors: Stephen C. VANDEWINCKEL, Livonia, NY (US); Francis W. WENZEL, Fairport, NY (US); Gregory T. GUILE, Atlanta, NY (US)

(21) Appl. No.: 13/240,427

(22) Filed: Sep. 22, 2011

Related U.S. Application Data
(60) Provisional application No. 61/344,727, filed on Sep. 22, 2010.

(51) Int. Cl. B30B 9/32

(52) U.S. Cl. 100/98 R

(57) ABSTRACT

A machine is provided that simultaneously perforates and crushes an incoming flow of waste containers to output perforated compressed containers. The machine includes a pair of counter rotating drums supported within a frame and separated by a compression gap into which the containers are fed. A guard mechanism on the cover of the frame produces a downward angle of entry that is substantially parallel to the rotating axis of the drums. The outer surface of each drum includes a pattern of grooved rings that form a plurality of channels. Positioned within alternate channels are a plurality of perforating tools arranged in an opposing helical pattern to create a staggered path that engages and traps the containers to produce a positive feeding flow of the containers into and through the gap where the containers are punctured and crushed.

This application is entitled to and hereby claims the priority of co-pending U.S. Provisional application Ser. No. 61/344,727, filed Sep. 22, 2010.

### BACKGROUND OF THE INVENTION

1. Field of the Invention

The present invention is related to the refuse, recycling and reclamation industry and, more particularly, to a machine for simultaneously perforating and compressing waste containers such as plastic bottles, metal cans and the like to decrease the volume of space occupied by the containers.

2. Description of the Related Art

Very large volumes of waste containers including plastic bottles and other containers, metal cans and similar recyclable materials are collected and sorted at recycling, reclamation, and transfer stations every day. The sorted material must then be stored and/or transported for disposition which may entail recovery of the material for reuse. Given the volume of material and the size constraints on both storage facilities and transport vehicles, a need exists for a machine that is able to efficiently compress the waste containers into a smaller storage and/or transport volume having increased density and thereby lower both transport and storage costs.

The following U.S. patents and patent application were reviewed in connection with this application and the present invention:

| | |
|---|---|
| U.S. Pat. No. 3,749,004 | U.S. Pat. No. 4,153,206 |
| U.S. Pat. No. 4,925,117 | U.S. Pat. No. 4,987,829 |
| U.S. Pat. No. 5,102,057 | U.S. Pat. No. 5,195,429 |
| U.S. Pat. No. 5,758,573 | |
| U.S. Publ. No. US 2009/0064877 | |

### SUMMARY OF THE INVENTION

In view of the foregoing, the present invention overcomes the difficulties of handling large volumes of waste containers including plastic bottles and metal cans suitable for recycling and/or reclamation by perforating and compressing the containers to increase the density of the material for storage or transport.

In accordance with this and other objects, the present invention is directed to a machine that simultaneously perforates and crushes an incoming flow of waste containers to output perforated compressed containers that take up less space. The machine includes a pair of side-by-side, horizontally-positioned counter rotating drums supported within a stable frame and separated by a compression gap into which the containers are fed. The counter rotation of the drums is driven by a suitable power source and the speed is controlled to ensure positive feed of the containers into the compression gap. Feeding of the containers is facilitated by a guard mechanism on the cover of the frame which produces a downward angle of entry that is substantially parallel to the rotating axis of the drums.

The outer surface of each drum includes a pattern of grooved rings that form a plurality of channels. Positioned within alternating channels are a plurality of projecting perforating tools. The perforating tools on the two drums are arranged in an opposing helical pattern such that each ring of projecting tools on one drum extends into an open channel on the opposite drum, crossing the compression gap, or interface, between the two drums. This pattern of projecting perforating tools and opposite open channels creates a staggered path that grabs and traps the containers to produce a positive feeding flow of the containers into and through the gap. As the containers pass through the compression gap between the drums, the perforating tools puncture the containers while, at the same time, the containers are crushed between the rings of the opposing drums. The output from the machine has a reduced volume and increased density as compared with the input, allowing more containers to fit into a given number of storage receptacles such as baling machines and recycling bins.

The projecting perforating tools are designed at such an angle and shape so as to maximize the puncture while allowing the perforated and compressed material to disengage from the tool after perforation. The height and angle of the tools are also designed to maximize tool life, reducing maintenance costs. Further, the grooved rings or channels on the periphery of each drum allow for maximum perforation and compression. The channels provide space for the perforating tools to work and pass through the container material. Additionally, the channels provide an interrupted surface which deforms the container while compressing it, thus helping to defeat the memory inherent in plastic containers. The decreased surface area arising from use of compression rings, spaced from each other by the channels, also requires less power during compression, thus resulting in efficient use of power.

The combination of the channels in each drum being aligned with the helical pattern of perforating tools on the opposed drum eliminates any requirement for timing between the power-driven drums. By eliminating the timing requirement, the configuration of the present invention allows for the use of any type of energy source for drum propulsion, such as one or more electric motors, hydraulic motors or other suitable energy source for machinery of the type embodied in the present invention.

In addition, the size of the compression gap between the opposed drums can be easily adjusted, given the elimination of timing between the drums. Adjustability of the compression gap allows the present invention to be used for a variety of container sizes and types. A control system can also be incorporated into the machine in order to allow for manual and/or automatic adjustment of the compression gap in the event varying sizes and types of containers are being perforated and compressed at the same time. Self-reversing drum rotation can also be included in the machine to clear any jammed or trapped material, via a control system employing hydraulic pressure switches or electronic torque sensors.

Accordingly, it is an object of the present invention to provide a perforating and compressing machine that is able to both puncture and crush waste containers at the same time.

Another object of the present invention is to provide a perforating and compressing machine in accordance with the preceding object that includes a pair of side-by-side counter rotating drums supported on a stable frame and separated from one another by a compression gap into which the containers are fed.

A further object of the present invention is to provide a perforating and compressing machine in accordance with the preceding objects in which feeding of the containers is facilitated by a guard mechanism on the frame cover which produces a downward angle of entry into the gap that is parallel to the rotating axis of the drums.

Yet another object of the present invention is to provide a perforating and compressing machine in accordance with the preceding objects in which the outer surface of each drum includes a pattern of grooved rings that form a plurality of channels within which a plurality of perforating tools are positioned in alternate channels on each drum.

A still further object of the present invention is to provide a perforating and compressing machine in accordance with the preceding objects in which the perforating tools on the two drums are arranged in an opposing helical pattern to create a staggered path that engages and traps the containers to produce a positive feeding flow of the containers into and through the gap.

Yet another object of the present invention is to provide a perforating and compressing machine in accordance with the preceding objects in which, at the interface between the two drums, both the perforating tools and the rings of the two drums are offset from one another such that there is no requirement for timing between the drums.

Still another object of the present invention is to provide a perforating and compressing machine that is not complex in structure and which can be manufactured at low cost but yet efficiently perforates and crushes waste containers while producing a positive feeding flow of the containers into the machine.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a front perspective view of a perforating and compressing machine in accordance with the present invention, shown with the housing cover elevated to reveal the drums.

FIG. 2 is a rear perspective view of the perforating and compressing machine shown in FIG. 1.

FIG. 3 is a partially transparent front view of the perforating and compressing machine of FIG. 1 with the housing cover closed.

FIG. 4 is a cross sectional view taken along line C-C of FIG. 3.

FIG. 5 is a top view of the two drums and axles forming a drum assembly of the perforating and compressing machine shown in FIGS. 1-4.

FIG. 6 is an enlargement of the area of the adjoining drums identified as Detail A in FIG. 5.

FIG. 7 is a side view of one of the perforating tools of the type mounted on the drums of the perforating and compressing machine shown in FIGS. 1-4.

FIG. 8 is a top view of the perforating tool shown in FIG. 7.

FIG. 9 is a perspective view of the drum assembly as shown in FIG. 5.

FIG. 10 is an end view of the drum assembly shown in FIG. 9.

FIG. 11 is an enlargement of the area of the adjoining drums identified as Detail B in FIG. 10.

FIG. 12 is another front perspective view of the perforating and compressing machine in accordance with the present invention with the housing cover mounted to the frame to enclose the drum assembly, shown with an output chute for the perforated and compressed containers exiting the machine and a frame extension for supporting a gas engine, if desired.

FIG. 13 is a front perspective view of the perforating and compressing machine shown in FIG. 12 with the housing cover elevated to reveal the drum assembly.

FIG. 14 is a cutaway front view of the perforating and compressing machine taken along line B-B of FIG. 12.

FIG. 15 is a cutaway side view of the perforating and compressing machine taken along line C-C of FIG. 12.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

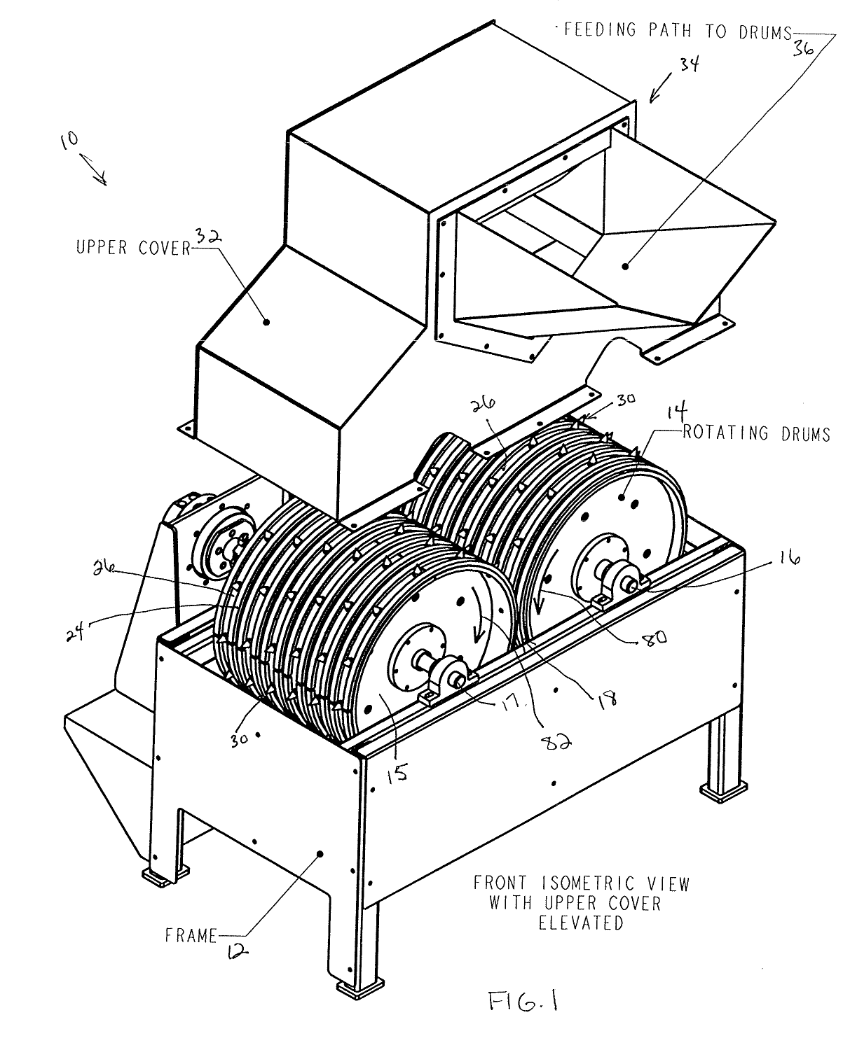

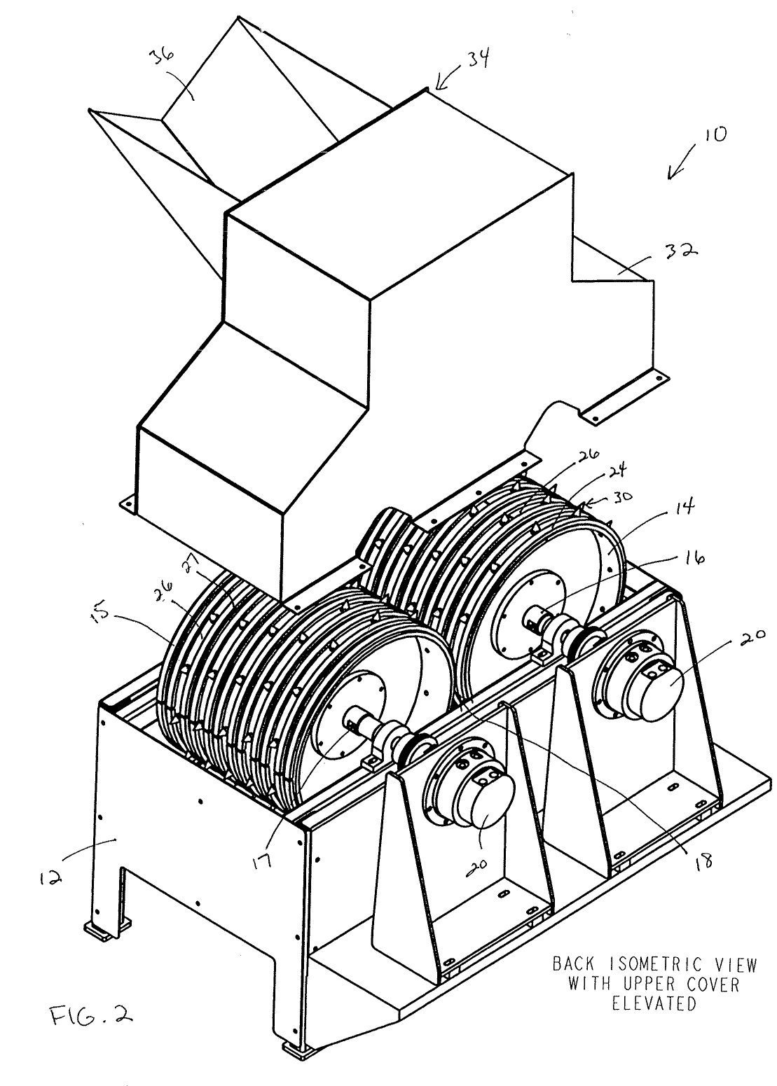

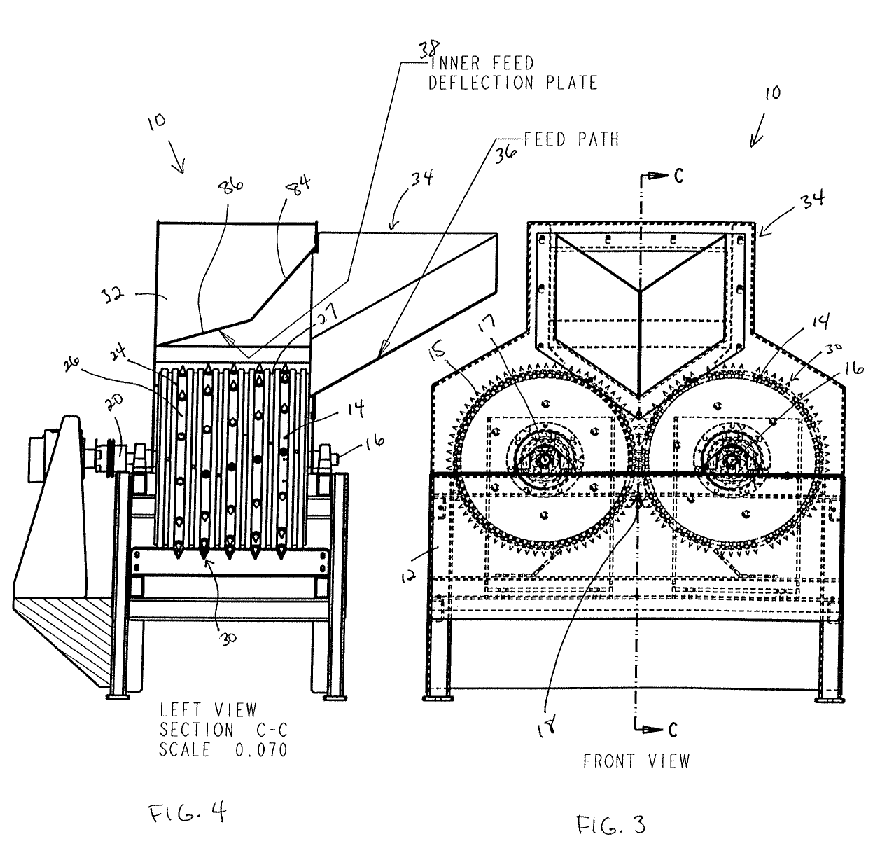

As shown in FIGS. 1-4, the present invention is directed to a perforating and compressing machine generally designated by reference numeral 10. The perforating and compressing machine 10 includes a stable frame 12 that supports a pair of side-by-side counter rotating drums 14, 15 on respective axles 16, 17. As mounted on the frame 12, the drums 14, 15 are positioned generally horizontally and are substantially parallel with one another. The drums are separated from one another by a compression gap, generally designated by reference numeral 18, through which waste containers pass for perforating and compressing. During operation, the drums 14, 15 are powered by hydraulic motors 20 or other power sources to rotate in opposite directions as indicated by the arrows 80, 82 in FIG. 1.

Due to the size of the drums 14, 15, the speed of their counter-rotation should be controlled in order to positively feed the containers to be perforated and crushed into the compression gap 18 between the drums. The speeds of the counter-rotating drums should preferably be controlled at the same level, but no timing mechanism is required, as in some of the prior art machines, and slippage can be tolerated in view of the unique design of the drums in accordance with the present invention. Hence, the counter-rotating drums 14, 15 may be propelled by any combination of hydraulic, mechanical and/or electrical devices.

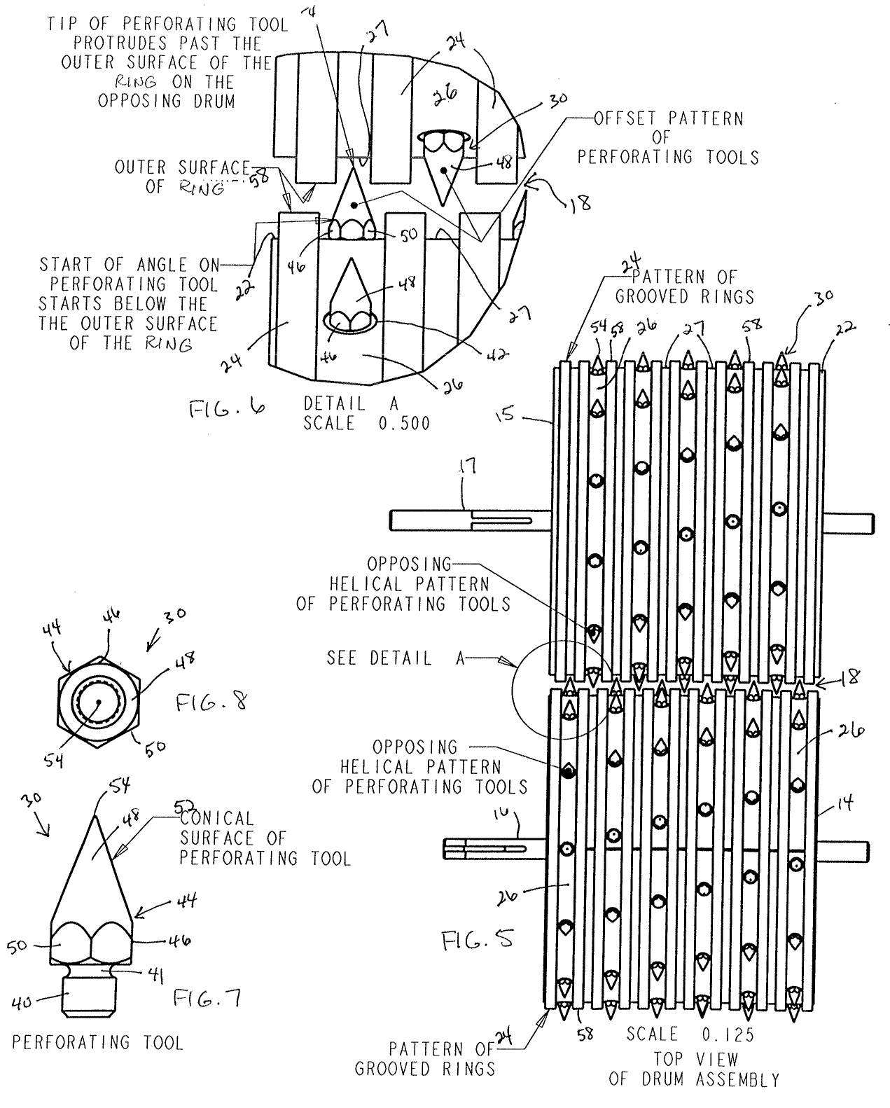

As shown in more detail in FIGS. 5, 6 and 9, the outer surface 22 of each drum 14, 15 includes a pattern of grooved rings 24 that form a plurality of alternating channels 26, 27. The channels 26 on one drum 14 are offset with respect to the channels 26 on the opposing drum 15 so as not to align therewith. Rather, the channels 26 on one drum align with the channels 27 on the other drum (see FIG. 6).

Positioned within the channels 26 on each drum 14, 15 are a plurality of projecting perforating tools generally designated by reference numeral 30. Channels 27 are open to provide space for the tools that project from the opposing drum. The perforating tools 30 on the two drums 14, 15 are arranged in an opposing helical pattern to create a staggered path that grabs and traps the containers to produce a positive feeding flow of the containers into and through the compression gap 18. As used herein, the phrases “positive feeding” and “positive feeding flow” mean that the containers, upon contacting the rotating drums 14, 15, are grabbed and pulled into the compression gap 18 by the arrangement and structure of the perforating tools 30 and rings 24. Without positive feeding, the containers could have the tendency to bounce around on top of the drums, requiring an operator to manually force them into the gap.

In an alternative embodiment, which is not preferred, instead of having the channels cut as grooves in the rings, the channels may be created by the axial spacing of a plurality of separate rings across the drum such that the annular spaces between the rings alternatingly form the tool-bearing channels 26 and the open channels 27. In order to provide a drum comparable to the drum shown in FIG. 5, which has six grooved rings forming the channels, the drum in the alternative embodiment would instead be provided with twelve individual rings.

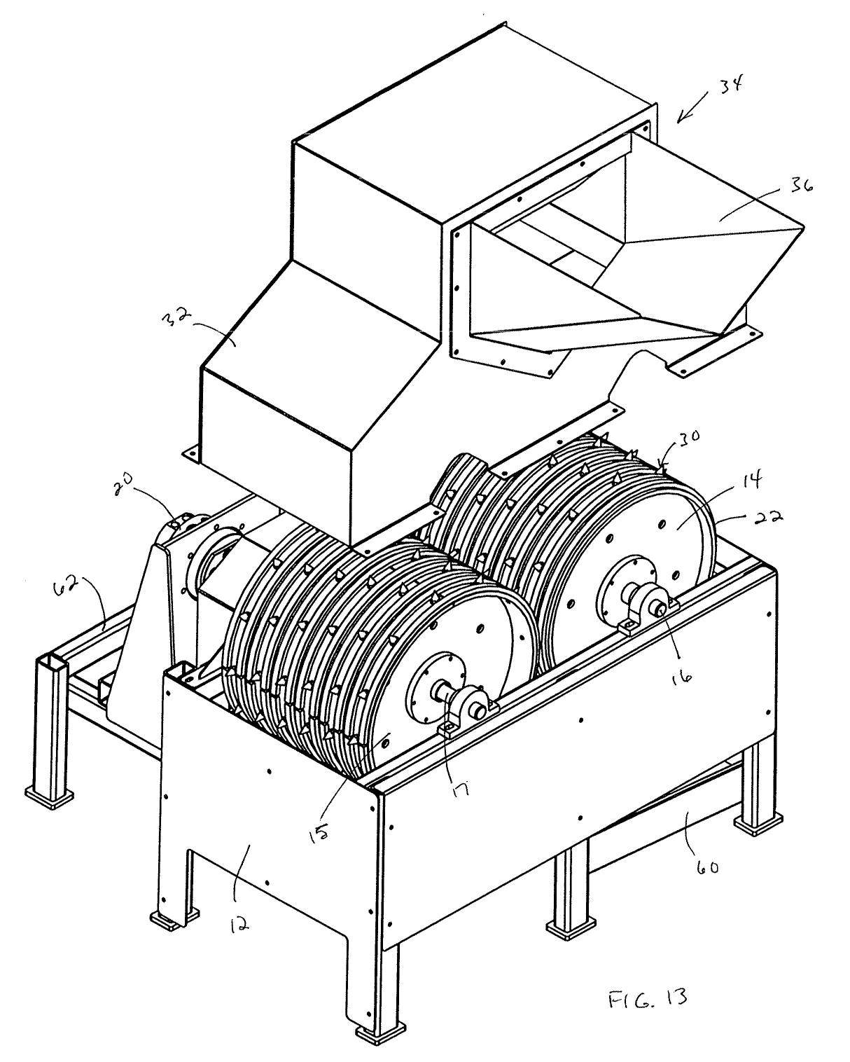

To further assist in achieving positive feeding, the upper cover 32 of the frame 12 has a guard mechanism generally designated by reference numeral 34 with a feed chute 36 through which the waste containers are directed toward the gap 18 between the drums (see FIGS. 1-4). The guard mechanism 34 provides protection from the rotating drums and includes an inner feed deflection plate 38 to produce a downward angle of entry that is substantially parallel to the axles 16, 17 and rotating axis of the drums 14, 15. This downward angle of entry and the action of the deflection plate 38 assist in ensuring that the containers are engaged by the perforating tools 30 when they contact the drums and are positively pulled into the compression gap 18 by the tools 30 and rings 24. The deflection plate 38 preferably has a leading portion 84 having a greater angle, and a trailing portion 86 having a lesser angle, to the upper surface of the counter-rotating drums 14, 15 so as to force the containers entering the machine through feed chute 36 into engagement with the perforating tools 30. As shown in FIGS. 6-8, one preferred embodiment of the perforating tools 30 has a threaded mounting end 40 for securing the tools within corresponding apertures 42 formed in the channels (see FIGS. 6 and 11), and a body generally designated by reference numeral 44. The body 44 includes a base 46 and a head 48. According to this embodiment, the tools 30 are screwed into the apertures 42 so that the relief 41 is fitted into aperture 42. The base 46 is generally cylindrical with flat machined surfaces 50 to cooperate with the tool. Other configurations and means of attaching the tools 30 to the drums 14, 15 could also be used, such as compression fitting, welding and the like, as would by understood by persons of ordinary skill in the art.

Above the generally cylindrical base 46, the head 48 of the tool has a conical surface 52 and a pointed tip 54 used to perforate the containers. The body 44 of the tool is designed at such an angle, height and shape so as to maximize puncture while allowing the waste containers to disengage from the tools following perforation. Preferably, the body 44 of the tools is from about 1.15 inches to about 1.625 inches in height, and most preferably about 1.4 inches in height. The conical head 48 is about 0.91 inches to about 1.41 inches in height, and most preferably about 1.16 inches in height. The conical surface has a slope of between about 35° and about 45°, and most preferably is about 40°. The height and angle also maximize tool life and reduce maintenance costs.

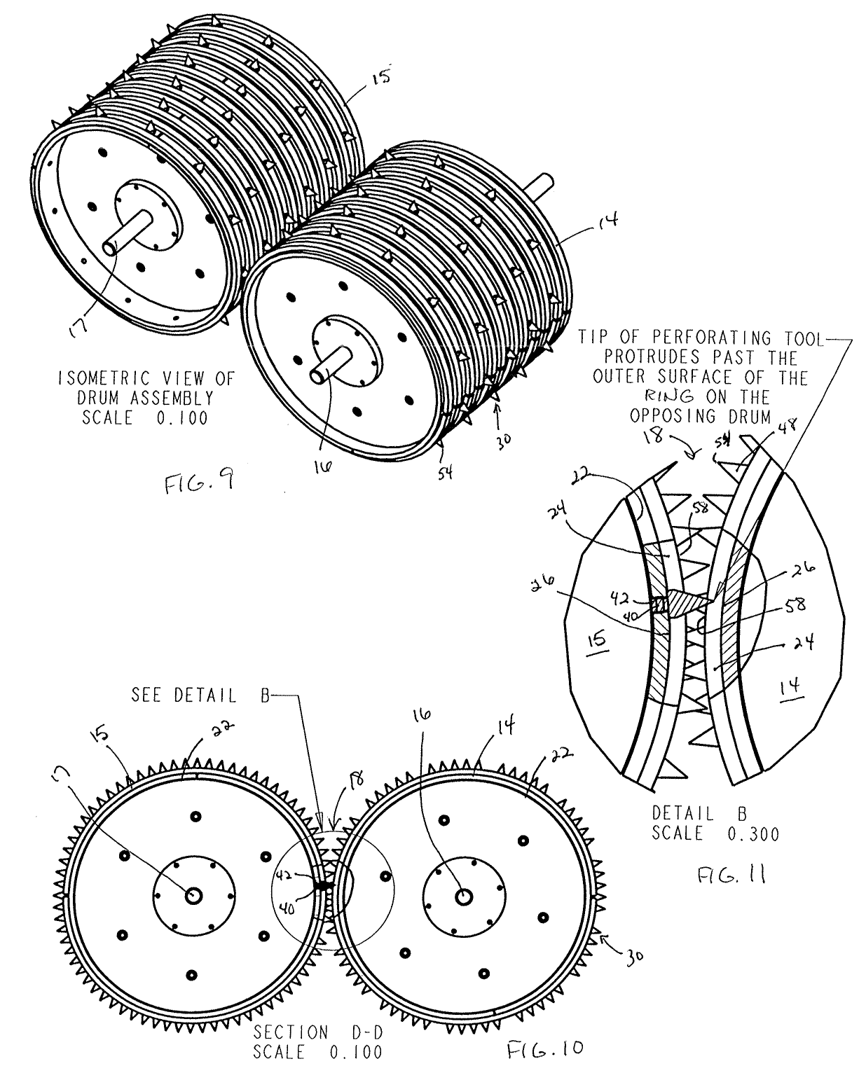

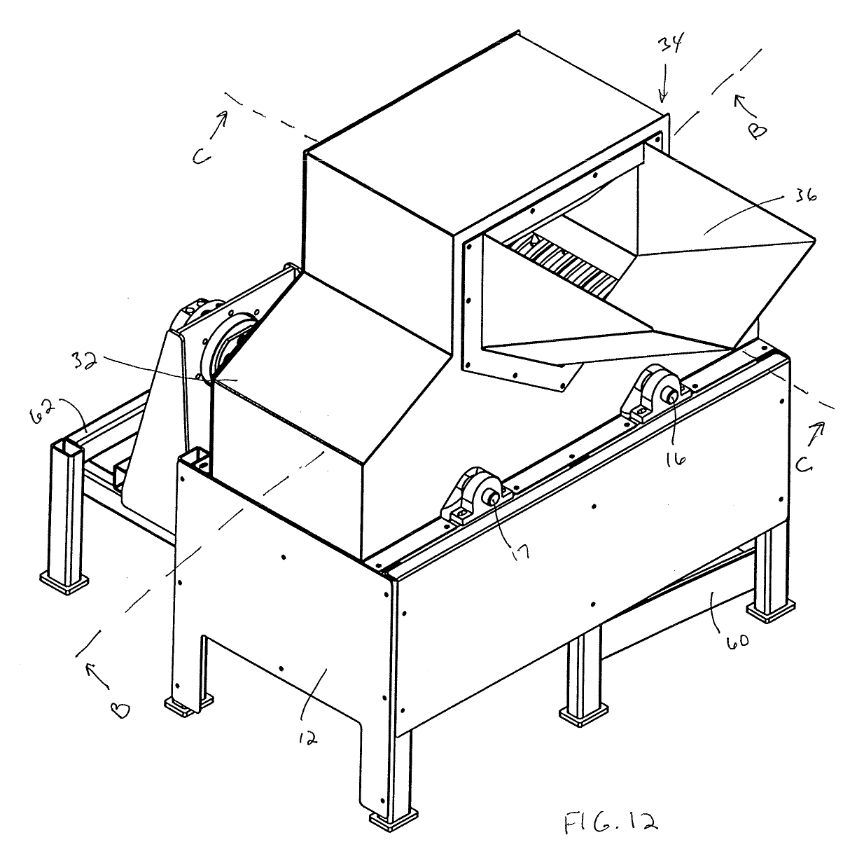

As can be seen in FIGS. 5, 6, 10 and 11, when the perforating tools 30 are mounted and the drums 14, 15 are properly spaced from one another, the tips 54 of the perforating tools 30 on one drum 14 protrude past the outer surfaces 58 of the rings 24 on the opposing drum 15 and into channels 27. This ensures both a highly effective puncture and as much compression of the containers as is feasible given the need to leave a large enough compression gap 18 to pass the containers through. In effect, the rings 24 provide space for the perforating tools 30 to work, while also providing an interrupted surface which deforms the containers while compressing them, helping to defeat the memory inherent in plastic materials.

In addition to the contribution made by the interdigitating relationship of the tool tips 54 on one drum, such as drum 14, with the rings 24 and channels 27 on the opposing drum, drum 15, in defining the nature of the gap and the effectiveness of the machine, the relationship between the body 44 of the tool and the channels 26 is also significant. In particular, as best shown in FIG. 6, the base 46 of the tool 30 is wholly received within the channel 26 with the conical surface 52 of the head 48 starting below the outer surface 58 of the adjacent ring 24. Hence, only the conical head 48 of the tool extends into and through the gap 18 while the base stays within the channel 26 and is prevented from catching on the containers by the rings, again ensuring disengagement of the compressed containers from the tools following perforation.

The combination of the rings 24 being offset so that the channels 26 on one drum 14 are aligned with open channels 27 on the other drum 15, in conjunction with the helical pattern of the perforating tools 30 eliminates any requirement for timing between the drums 14, 15. By eliminating a timing requirement, virtually any type of energy source may be used for drum propulsion. Further, as described earlier, the speed of the drums 14, 15 should be controlled so that the drums counter-rotate at preferably the same speed, although no timing mechanism is required and slippage can be tolerated in view of the machine design of the present invention. By controlling the RPM of the drums, positive feed of the material to be perforated and crushed can be ensured.

One mechanism for controlling the RPM of the drums is a control unit (not shown) that not only is configured to vary the RPM of the drums but also is able to adjust the compression gap 18 between the drums on an automatic and/or manual basis. Adjustment of the gap allows for varying sizes and types of containers to be passed through the machine.

In addition, the machine is preferably configured with a self-reversing drum rotation capability to clear any jammed or trapped material from the gap. Self-reversing drum rotation may be controlled by the control unit employing hydraulic pressure switches or electronic torque sensors. Other means of powering such a function could also be used as would be understood by persons of ordinary skill in the art.

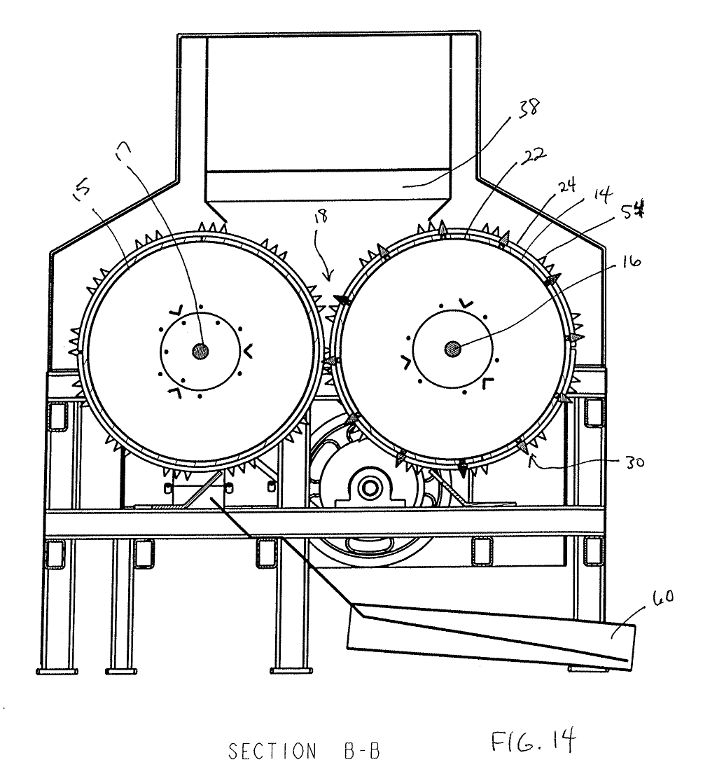

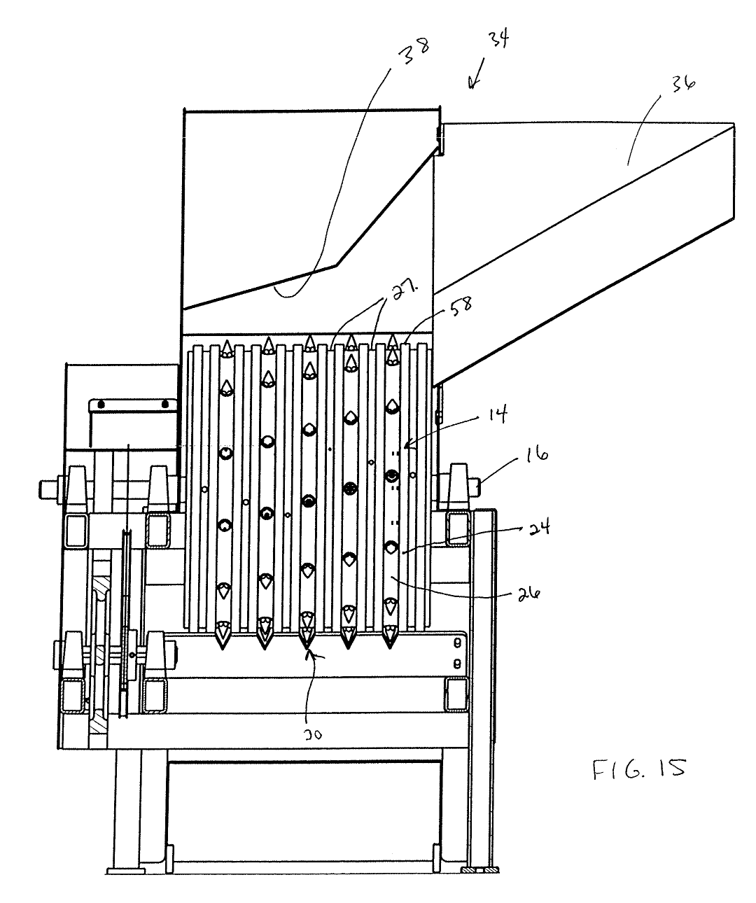

Once the material has been perforated and crushed, the material may be transported by adjoining conveyors or chutes. FIGS. 12-15 illustrate various views of the machine in accordance with the present invention as equipped with an output chute 60 for controlling the flow of compressed material out of the machine. As also shown in FIGS. 12-15, the perforating and compressing machine may further include a frame extension 62 to support a motor (not shown) when the machine is configured with a gas-powered motor or similar power source for driving rotation of the drums.

As described herein, the perforating and compressing machine according to the present invention compresses waste containers and other materials, thereby increasing the density of the subsequent packaging. The increase in density provides an economic benefit by lowering transport and storage costs. The perforations remove entrapped air from the containers and also provide an interrupted surface that assists in positive feeding during the compression. These steps decrease the volume of space occupied by the container. With the volume decreased and the entrapped air removed, more containers will fit into the same number of storage receptacles.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A machine for perforating and compressing plastic containers comprising:
a frame;
a pair of side-by-side counter rotating drums supported by said frame on respective axles, said drums being positioned generally horizontally and substantially parallel with one another;
said drums spaced apart to establish a compression gap therebetween through which the plastic containers pass for perforating and compressing;
an outer surface of each drum including a pattern of spaced rings that form a plurality of first channels and a plurality of second channels, said first and second channels alternating with one another on each drum, the first channels on one drum being in alignment with the second channels on the opposing drum and offset with respect to the first channels on the opposing drum; and
a plurality of projecting perforating tools positioned within the first channels of each drum, said second channels of each drum being open to provide space for the tools that project from the opposing drum, said perforating tools on the two drums being arranged to grab and trap the plastic containers to produce a positive feeding flow of the containers into and through the compression gap.

2. The perforating and compressing machine as set forth in claim 1, wherein said perforating tools on the two drums are arranged in an opposing helical pattern to create a staggered path, said staggered path in combination with the alignment of the first channels and perforating tools on one drum with the open second channels on the opposing drum resulting in relative rotational speeds of the two drums being independent so that no timing mechanism is required to synchronize the relative speeds of the two drums.

3. The perforating and compressing machine as set forth in claim 2, wherein said counter-rotating drums may be propelled by any combination of hydraulic, mechanical and/or electrical devices due to the absence of any timing requirement.

4. The perforating and compressing machine as set forth in claim 1, wherein perforating tips of the perforating tools on one drum protrude past outer surfaces of the rings on the opposing drum and into the second channels to ensure a highly effective puncture of said plastic containers.

5. The perforating and compressing machine as set forth in claim 4, wherein the rings are configured to provide space for the perforating tools to work, while also providing an interrupted surface which deforms the containers while compressing them, helping to defeat material memory inherent in plastic materials.

6. The perforating and compressing machine as set forth in claim 1, wherein the first channels have apertures formed therein, each of said perforating tools having a threaded mounting end for securing the tools within a respective aperture.

7. The perforating and compressing machine as set forth in claim 6, wherein each of said tools further includes a body above the threaded mounting end, said body having a base and a head with the head having a conical surface and a pointed tip used to perforate the containers.

8. The perforating and compressing machine as set forth in claim 7, wherein the base of the tool is wholly received within the first channel with the conical surface of the head starting below an outer surface of an adjacent ring so that only the conical head of the tool extends into and through the compression gap while the base stays within the first channel and is prevented from catching on the containers by the rings, ensuring disengagement of the compressed containers from the tools following perforation.

9. The perforating and compressing machine as set forth in claim 8, wherein the body of each tool is from about 1.15 inches to about 1.625 inches in height, with the conical head being about 0.91 inches to about 1.41 inches in height.

10. The perforating and compressing machine as set forth in claim 8, wherein the conical surface has a slope of between about 35° and about 45°.

11. The perforating and compressing machine as set forth in claim 1, wherein said spaced rings include a plurality of grooved rings, said second channels being formed by grooves in said rings and said first channels being formed by annular areas between adjacent grooved rings.

12. The perforating and compressing machine as set forth in claim 1, wherein said frame includes an upper cover having a guard mechanism with a feed chute through which the waste containers are directed toward the compression gap between the drums, said guard mechanism providing protection from the rotating drums and including an inner feed deflection plate that produces a downward angle of entry for incoming containers that is substantially parallel to the axles and rotating axis of the drums.

13. The perforating and compressing machine as set forth in claim 12, wherein said deflection plate has a leading portion with a greater angle, and a trailing portion with a lesser angle, relative to upper surfaces of the counter-rotating drums.

14. A machine for perforating and compressing plastic containers comprising:
a pair of side-by-side counter rotating drums supported on respective axles and positioned generally horizontally and substantially parallel with one another;
a compression gap separating the two drums through which the plastic containers pass for perforating and compressing;
an outer surface of each drum including a pattern of alternating first channels having projecting perforating tools mounted therein and open second channels, the first channels on one drum being in alignment with the second channels on the opposing drum so that the open second channels of each drum provide space for the perforating tools that project from the first channels on the opposing drum, said perforating tools on the two drums being arranged in an opposing pattern to create a staggered path to grab and trap the containers to produce a positive feeding flow of the containers into and through the compression gap; and
a speed of each drum being independent of a speed of the opposing drum so that relative speeds of the two drums do not have to be synchronized but can differ from one another.

15. The perforating and compressing machine as set forth in claim 14, wherein said first and second channels are formed by spaced rings having an outer cylindrical surface with a diameter greater than an outer diameter of both said first and second channels.

16. The perforating and compressing machine as set forth in claim 15, wherein pointed tips of the perforating tools on one drum protrude past the outer cylindrical surfaces of the rings on the opposing drum, through the compression gap and into the second channels on said opposing drum to ensure a highly effective puncture of said plastic containers.

17. The perforating and compressing machine as set forth in claim 16, wherein said spaced rings include a plurality of grooved rings, said second channels being formed by grooves in said rings and said first channels being formed by annular areas between adjacent grooved rings, said grooved rings being configured to provide an interrupted surface which deforms the containers while compressing them, helping to defeat material memory inherent in plastic materials.

18. The perforating and compressing machine as set forth in claim 15, wherein each of said tools includes a body having a base and a head, the head having a conical surface and a pointed tip used to perforate the containers.

19. The perforating and compressing machine as set forth in claim 18, wherein the base of each tool is wholly received within the first channel in which the tool is mounted, the conical surface of the tool's head starting below the outer cylindrical surface of an adjacent ring so that only the conical head of the tool extends into and through the compression gap while the base stays within the first channel and below the outer cylindrical ring surface so that the rings prevent the bases from catching on the containers, ensuring disengagement of the compressed containers from the tools following perforation.

20. The perforating and compressing machine as set forth in claim 19, wherein the body of each tool is from about 1.15 inches to about 1.625 inches in height, the conical head is from between about 0.91 inches to about 1.41 inches in height, and the conical surface has a slope of between about 35° and about 45°.
